(19) United States
(12) Patent Application Publication
(10) Pub. No.: US 2007/0143042 A1
(43) Pub. Date: Jun. 21, 2007

(54) Processes and systems for providing analytical device analysis advisory information

(76) Inventors: Gordon M. Stewart, Loveland, CO (US); Robert D. Ricker, Loveland, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/305,691

(22) Filed: Dec. 16, 2005

(51) Int. Cl. G01N 11/00

(52) U.S. Cl. 702/50

(57) ABSTRACT

Processes and systems for providing analytical device analysis advisory information are provided. Aspects of the subject processes and systems include use of an advisory module that generates analytical device analysis advisory information based on a sample identifier and instrument parameter. Also provided are computer program products for use in executing the subject processes.

### BACKGROUND OF THE INVENTION

Analytical chemistry is the analysis of samples to gain an understanding of their chemical composition. The goal of many chemical analysis protocols is to analyze a given sample (e.g., a physiological sample, an environmental sample, a manufacturing sample, etc.) for a variety of different purposes, such as to identify the presence of one or more analytes of interest in the sample, to characterize the makeup of the sample, for example in quality control, etc.

Many different analytical chemistry protocols have been developed. One broad category of analytical protocols that have been developed is chromatography. Chromatography is a family of analytical chemistry techniques for the separation of mixtures. In chromatography, a sample (the analyte) in a “mobile phase”, often in a stream of solvent, is passed through a “stationary phase”, where the stationary phase is some form of material that will provide a rigid support for material that interacts to varying degrees with components of the sample. Usually, each component has a characteristic separation rate that can be used to identify it and thus the composition of the original mixture.

A chromatograph takes a chemical mixture carried by liquid or gas and separates it into its component parts as a result of differential distributions of the solutes as they flow around or over a stationary liquid or solid phase. Various techniques for the separation of complex mixtures rely on the differential affinities of substances for a gas or liquid mobile medium and for a stationary adsorbing medium through which they pass, such as paper, gelatin, or magnesium silicate gel.

Many different chromatographic analytical devices have been developed in order to perform various chromatographic protocols. Examples of various chromatographic devices include, but are not limited to: gas chromatography devices, liquid chromatography devices, capillary electrophoresis devices, and supercritical fluid chromatography devices.

Chromatographic devices are typically operated according to an analytical device method, which method is used by a chromatographic device data system (e.g., such as the ChemStation system from Agilent Technologies, Palo Alto, Calif.) to provide all of the setpoints for a device to perform a given sample analysis. As such, an analytical device method generally at least includes instrument control, sample injection and data analysis setpoints.

Traditionally, analytical device users run a given analysis using a method that is chosen based on a number of factors, such as user experience, literature read by the user, manufacturer recommendations, etc. As such, users rely on their own knowledge in order to identify a method to use with a given sample, and cannot readily access the collective knowledge of other analytical device operators. Furthermore, it is difficult for users to know whether their given analytical device and method is the best suited for a given sample, or whether the method could be better performed by another entity (i.e., assayer) who could achieve better results and/or perform the analysis at a lower cost.

Accordingly, it would be beneficial if a user could access the collective knowledge of other analytical device professionals in identifying the method to employ for a given sample, e.g., in terms of identifying an optimal analytical device method for the user to employ or identifying another entity that could analyze a sample better than could the user. The present invention provides this and other capabilities.

### SUMMARY OF THE INVENTION

Processes and systems for providing analytical device analysis advisory information are provided. Aspects of the subject processes and systems include use of an analytical device analysis advisory module that generates analytical device analysis advisory information based on a sample identifier and instrument parameter. In certain embodiments, the advisory module includes a memory having a plurality of different sample identifiers and instrument parameters each linked to at least one analytical device method or an identifier thereof (e.g., where the identifier identifies an assayer that can analyze the sample). Also provided are computer program products for use in executing the subject processes.

### BRIEF DESCRIPTIONS OF THE DRAWINGS

FIG. 1 provides a flow chart diagram of a first embodiment of a process employing an advisory module to generate advisory information for analytical device analysis of a sample according to an embodiment of the invention.

FIG. 2 schematically illustrates a system having an advisory module of a representative embodiment of the subject invention.

FIG. 3 provides a flow chart diagram of a second representative embodiment of a process employing an advisory module to provide advisory information that includes an analytical device method.

FIG. 4 provides a flow chart diagram of a representative embodiment of a process employing an advisory module to obtain advisory information that includes the identity of an assayer that can analyze the sample.

FIG. 5 provides a flow chart diagram of an embodiment of a process employing an advisory module to obtain advisory information that includes both an analytical device method and the identity of an assayer that can analyze the sample, thereby providing a choice to the user.

### DEFINITIONS

Unless defined otherwise, all technical and scientific terms used herein have the same meaning as commonly understood by one of ordinary skill in the art to which this invention belongs. Still, certain elements are defined below for the sake of clarity and ease of reference.

By “remote location,” it is meant a location other than the location at which a referenced item is present, e.g., a location apart from an analytical device, such as another physical location, (e.g., office, lab, etc.) in the same city, another location in a different city, another location in a different state, another location in a different country, etc. As such, when one item is indicated as being “remote” from another, what is meant is that the two items are at least in different areas of the same room, such as in different rooms or different buildings, and may be at least one mile, ten miles, or at least one hundred miles apart.

“Communicating” information references transmitting the data representing that information as signals (e.g., electrical, optical, radio signals, etc.) over a suitable communication channel (e.g., a private or public network), for example, a Wide Area Network (“WAN”), telephone network, satellite network, or any other suitable communication channel, including the Internet, an Intranet, etc. Communicating may occur using any convenient communication module suitable for the type of communication channel used, such as a computer network card, a computer fax card or machine, or a telephone or satellite modem.

“Forwarding” an item refers to any means of getting that item from one location to the next, whether by physically transporting that item or otherwise (where that is possible) and includes, at least in the case of data, physically transporting a medium carrying the data or communicating the data, e.g., via ways described above.

The terms “system” and “computer-based system” refer to the hardware means, software means, and data storage means (e.g., a memory) used to practice aspects of the present invention. The minimum hardware of the computer-based systems of the present invention includes a central processing unit (CPU), input means, output means, and data storage means (e.g., a memory). A skilled artisan can readily appreciate that many computer-based systems are available which are suitable for use in the present invention. The data storage means may include any manufacture having a recording of the present information as described above, or a memory access means that can access such a manufacture.

A “processor” references any hardware and/or software combination that will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

A “memory,” “memory element” or “memory unit” refers to any device that can store information for subsequent retrieval by a processor, and may include magnetic or optical devices (such as a hard disk, floppy disk, CD, or DVD), or solid-state memory devices (such as volatile or non-volatile RAM). A memory or memory unit may have more than one physical memory device of the same or different types (for example, a memory may have multiple memory devices such as multiple hard drives or multiple solid state memory devices or some combination of hard drives and solid state memory devices).

In certain embodiments, a system includes hardware components which take the form of one or more platforms, e.g., in the form of servers, such that any functional elements of the system, i.e., those elements of the system that carry out specific tasks (such as managing input and output of information, processing information, etc.) of the system may be carried out by the execution of software applications on and across the one or more computer platforms represented of the system. The one or more platforms present in the subject systems may be any convenient type of computer platform, e.g., such as a server, main-frame computer, a work station, etc. Where more than one platform is present, the platforms may be connected via any convenient type of connection, e.g., cabling or other communication system including wireless systems, either networked or otherwise. Where more than one platform is present, the platforms may be co-located or they may be physically separated. Various operating systems may be employed on any of the computer platforms, where representative operating systems include Windows, Sun Solaris, Linux, OS/400, Compaq Tru64 Unix, SGI IRIX, Siemens Reliant Unix, and others. The functional elements of system may also be implemented in accordance with a variety of software facilitators and platforms, as is known in the art.

### DETAILED DESCRIPTION

Processes and systems for providing analytical device analysis information are provided. Aspects of the subject processes and systems include use of an advisory module that generates analytical device analysis information based on a sample identifier and instrument parameter. In representative embodiments, the advisory module includes a memory having a plurality of different sample identifiers and instrument parameters each linked to at least one analytical device method or an identifier thereof (e.g., where the identifier identifies a third-party assayer that can analyze the sample). Also provided are computer program products for use in executing the subject processes.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, certain methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

As summarized above, the subject invention provides processes and systems for use in providing advisory information to a user for assaying a sample with an analytical device. Specifically, aspects of the invention provide processes and systems for providing guidance or evaluation information or details about how to analyze a sample with an analytical device, where the details may include one or more of: (a) an evaluation of whether a given method for a given sample can provide the best results; (b) a suggestion of how to modify a given method for a given sample; (c) a suggestion of an alternative method for a given sample; (d) a suggestion of a third party that can better analyze a sample, e.g., in the form of an identifier of another entity (e.g., an entity that is distinct from the entity which is initially interested in analyzing the sample) that can analyze the sample with an analytical device; etc., where these distinct embodiments are reviewed in greater detail below. As such, the phrase “advisory information” is used broadly herein to collectively refer to any type of information concerning analysis of a given sample on an analytical instrument, where the information may be as simple as an evaluation of a proposed analytical device method to be run by the user (e.g., whether the method is the best method for analyzing the sample), or a recommendation for another party to analyze the sample (e.g., an assayer), or more complex, such as an analytical device method, e.g., as identified from a memory comprising a plurality of methods linked to sample identifiers, or one or more modification suggestions for a method loaded on a instrument, as described in greater detail below. In any event, the subject processes and systems provide sample analysis protocol advisory information to a user in response to submission by a user of a sample identifier and an instrument parameter.

The term “analytical device” is used broadly herein to refer to any type of device that performs an analysis of a sample. In certain embodiments, the analytical device is an analytical chemistry device, which is a device that analyzes samples to obtain an understanding of their chemical composition. Of interest in certain embodiments are mass spectrometry devices (MS), and chromatographic devices, including both liquid (LC) and gas chromatographic (GC) devices. Of interest are the following representative analytical systems: Agilent Technologies GC or GC/MS systems, including 6890N GC, 5973 Inert MSD, 5973N GC/MS, 6850 Series 11 Network GC and 6850 Series Network GC, 3000 Micro GC, 6820 GC, etc. The analytical devices for which the subject invention develops methods are, in certain embodiments, devices run by a data system, which data system uses setpoints provided by a given analytical device method to operate an analytical device to perform a given sample analysis.

As indicated above, in certain embodiments, the advisory information that is provided by the subject processes and systems is a complete analytical device method. By “analytical device method” is meant all of the setpoints required by a data system to operate an analytical device or collection of analytical devices to perform a given sample analysis. In certain embodiments, an analytical device method obtained by the subject processes includes instrument control, sample injection and data analysis setpoints. As such, a given analytical device method includes a plurality of different analytical device method parameters. By analytical device method parameter is meant a setpoint (or information used to determine a setpoint) that can be combined with additional setpoints to make up a complete analytical device method. A given method parameter can be categorized according to the subpart or division of the overall method of which it is a member. For example, where a given method includes instrument control, sample injection, detector and data analysis subsets of setpoints, the parameter may be an instrument control parameter, a sample injection parameter, or a data analysis parameter. By instrument control parameter is meant information that runs the device during a given sample analysis. Where the analytical device method is a method for running a gas chromatographic analytical device, examples of instrument control parameters or information include, but are not limited to: oven temperature profiles, carrier gas flow profiles, detector setpoints, etc. By sample injection parameter is meant information about sample injection for a given method, such as: injection volume, sample washes, equilibration time, load time, inject time, and the like. By data analysis profile parameter is meant information about how obtained data is analyzed by the system and presented by the system to the user, where for gas chromatographic analytical device, representative data analysis parameters or information include, but are not limited to: retention times, response factors, calibration amounts, physical constants, report templates, custom calculations, peak grouping, pattern recognition, integration, etc.

In yet other embodiments, the advisory information that is provided to the user is information that includes one or more method modification suggestions, e.g., in the form of one or more suggested setpoint changes, where the advisory information does not, however, include a complete analytical device method.

In yet other embodiments, the advisory information that is provided to the user is information that includes one or more different instrument suggestions, e.g., in the form of one or more suggested different types of instruments that could be used in analyzing the sample, e.g., to obtain a better result, where the advisory information may take the form of any type of instrument identifier.

In yet other embodiments, the advisory information that is provided by the subject processes and systems is an identifier of an entity distinct from the initial entity, e.g., user that is interested in analyzing the sample. This second entity may be an individual, collection of individuals, company, etc., that has capability of performing (or having performed by yet another entity) the desired analysis on the sample. For convenience, this entity that analyzes the sample (or refers either directly or through one or more mediators a project to yet another entity who analyzes the sample) is conveniently referred to herein as an assayer. As such, in these embodiments the assayer is the entity that can perform an analysis of the sample. As such, in these embodiments, the information that is provided to the sample identifier submitter, e.g., user of the system, about how to analyze the sample is information about an entity or individual that can analyze the sample, as opposed to an analytical device method per se that can be used directly by the sample submitter with an analytical device to analyze the sample.

In yet other embodiments, the advisory information that is provided to the user includes an evaluation of how well a given method can analyze a given sample, e.g., in the form of a confirmation that the results that have been obtained or can be obtained on a given sample with a given method on a given instrument are the best results possible.

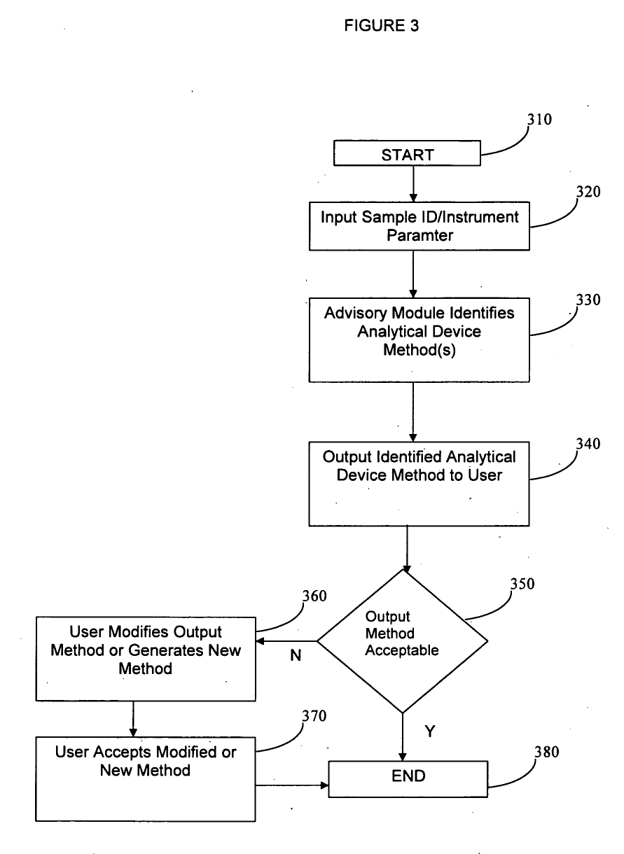

In yet other embodiments, the advisory information that is provided and returned to the user may include a combination of the above types of information, e.g., an analytical device method as well as the identity of one or more assayers who can perform an analysis of the sample, e.g., so that a choice is provided to the sample submitter of either performing the analysis or having a third party perform the analysis. Each of these embodiments is further described with reference to FIGS. 3 to 5 below.

In performing the processes of the present invention, a system that includes an analysis advisory module is employed. Specifically, a user submits to such a system a sample identifier and, in response to the submission of the sample identifier, receives from the system advisory information, as exemplified above, for analyzing the sample. As employed herein, the term “user” refers to a party or entity, e.g., individual, company, etc., that wishes to analyze a given sample using an analytical device. For convenience in describing the invention, the user may be referred to herein as an individual. However, it is understood that the term user may refer collectively to a plurality of individuals, e.g., members of a company, etc.

Aspects of the invention include an initial step of obtaining a sample identifier and an instrument parameter from a user, where the instrument parameter is one or more items of information or date about an analytical device that the user has used, is using or intends to use in the analysis of a given sample. This step of obtaining typically includes communicating the sample identifier and instrument parameter to a system that includes an advisory module. The sample identifier that is communicated to the system may vary considerably, where representative identifiers include, but are not limited to: the name of the sample, the source of the sample, a coded identifier of the sample, a chromatographic result for the sample, etc. The term “sample identifier” specifically includes a description of the sample composition, either generic (for example, protein mixture, antibody composition, solvent type, and the like) or specific (for example, the sample contains a named chemical compound, named hormone, and the like). However, in certain embodiments, the sample identifier is not sample source information, e.g., injection volume or injection source, as described in copending application Ser. No. 11/144,199 filed on Jun. 2, 2005.

In addition to the sample identifier, an instrument parameter(s) for the analytical device of interest is also communicated to the system that comprises the advisory module. The term “instrument parameter” is employed to refer to a piece of information about the analytical device instrument, where representative instrument parameters of interest include, but are not limited to: information about the analytical device (e.g., analytical device type, make or model, etc.) or consummables (e.g., column type, mobile phase etc.) and operating parameters (e.g., pressure, oven temperature etc.) and the like, to be used therewith in a contemplated analysis of the sample by the user. One or more instrument parameters may be communicated to the advisory module system in this step of the subject processes.

In certain embodiments, additional information may also include other parameters that a given protocol identifier module will employ to identify a protocol for the user, such as price information (e.g., the amount a user is willing to pay a third party assayer for assaying the sample), quality information (e.g., qualifications required for any suggested third party assayers), etc.

As indicated above, communication may be by any convenient means, where in representative embodiments communication is by electronic communication means, such as via the Internet. As such, the sample identifier and instrument parameter, and other information desired to be input into the advisory module system, may be communicated to the advisory module system using any convenient protocol. In certain embodiments, the information may be manually input into the system, (e.g., via a graphical user interface or some other convenient input element, etc), such that the user obtains the information and then enters it into the system. In yet other embodiments, at least some of the information may be retrieved from a memory element of the analytical device that has analyzed, is analyzing or will analyze the sample. In these embodiments, the information may be retrieved by the system in a manner that is mediated by a user, e.g., where a user allows the information to be retrieved in response to a request. In yet other embodiments, the information may be retrieved by the system in a manner that is free of user intervention, e.g., where the system automatically uploads the information from a memory element of the analytical instrument, e.g., by an analytical instrument automatically forwarding the identifier and/or instrument parameter, optionally along with any desired additional information, to a system of the invention. In certain embodiments, identifier and/or sample identifier information may be automatically obtained by a first system, e.g., by an analytical device instrument, e.g., by machine reading a coded sample with a reader element of the system, reading a barcode on a consummable, e.g., column, etc., and this automatically obtained information then automatically forwarded to the system having the protocol identifier module. In certain embodiments, one or more instrument parameter is retrieved by the system from a memory element of the analytical device in a manner that is free of user intervention.

Following receipt into the advisory module system of the sample identifier and instrument parameter(s), and any additional information, from the user, the advisory module of the system uses the input information to generate analytical device analysis advisory information, e.g., advisory information for chromatographic analysis of a sample, as reviewed in greater detail below. The advisory information is then communicated from the system back to the user, so that the user obtains the advisory information in response to at least the sample identifier and instrument parameter(s) obtained from the user.

As reviewed above, the advisory information that is returned to the user is information about analysis of the sample, which may be a variety of different types of information, including but not limited to: an indication that a proposed analytical device method by the user is not optimal for analysis of a given sample; an evaluation of whether the results that will be or have been obtained from a given method on a given sample are the best that can be obtained; a recommendation for modification of one or more setpoints in the method, e.g., that will provide for better results; a recommendation of an assayer other than the user that can analyze the sample in some optimal way, e.g., to provide better results, to perform the analysis in a more cost effective manner; one or more recommended analytical device methods; and the like.

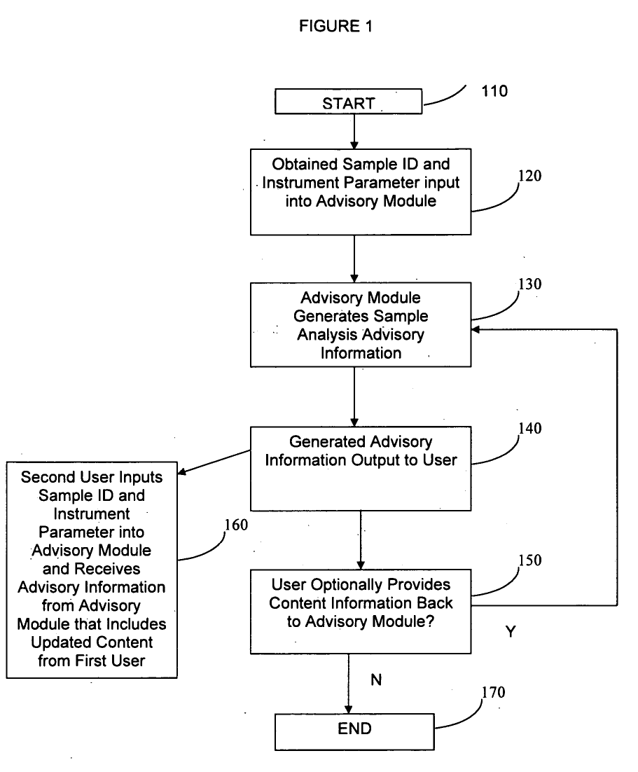

A flow chart diagram of a representative embodiment of the subject processes is provided in FIG. 1. As shown in FIG. 1, a user starts the process by identifying a sample to be analyzed at the step 110 labeled start. An identifier of the to be analyzed sample and an instrument parameter obtained and input into the advisory module at step 120. As reviewed above, the sample identifier may be the name of the sample (e.g., in terms of source, date or other identifying parameters), a coded identifier of the sample (e.g., a barcode), etc. As reviewed above, the instrument parameter(s) may vary, and may be, e.g., instrument type, column type, carrier type, pressure type, oven temperature, etc. As such, at step 120, at least a sample identifier and instrument parameter is obtained from a user (e.g., a researcher that is analyzing a sample of interest) and input into the advisory module, e.g., via an interface element, such as a graphical user interface (GUI). While not true of all embodiments, in representative embodiments the user and the advisory module are remote from each other, where the term remote is employed as defined above.

The actual point in time at which the sample identifier/instrument parameter information is communicated to the advisory module may vary, as desired. In certain embodiments, the communicating occurs before the sample is assayed by the user. In yet other embodiments, the communicating occurs while the sample is being assayed by the user, e.g., on an analytical device present at the user location. In yet other embodiments, the communicating occurs after the sample has been assayed at the first location on an analytical device.

At step 130, the advisory module advisory information for the sample based on the input sample identifier/instrument parameter information (and any other information (e.g., price), as desired). In this step, the advisory module takes the sample identifier/instrument parameter information, and optional other information (if submitted) and uses the input information to generate advisory information, e.g., according to predetermined evaluation criteria. The predetermined evaluation criteria may be as simple searching a database for methods or method identifiers linked to a particular sample type to be analyzed on a given instrument. In yet other embodiments, the predetermined evaluation criteria may be more complex, e.g., where the system evaluates two or more candidate methods or identifiers thereof and chooses among the candidates a “best fit” for the user that based on the submitted sample; or where there is no exact match up between the sample identifiers present in the module and the sample identifier submitted by the user, the system matches up the sample identifier with the “closest” sample identifier, e.g., as determined using a sample similarity functionality. Any convenient similarity functionality may be employed in such embodiments, where similarity may be based on a number of different factors. For example, the samples in the system may have a number of attributes or characteristics assigned to them, e.g., by the user, automatically or by import from existing databases (or any combination of these three), to provide for a result based on the desired amount of information. In providing the result, the result may include a single sample or ranking of two or more samples.

Following generation of the advisory information, the advisory information is then output to the user at step 140. As indicated above, the output advisory information may be made up of one or more analytical device methods or setpoint suggested modifications thereof, identifiers (e.g., contact information) for one or more assayers, evaluation information for a given method on a given instrument for a given sample, a combination of one or more analytical device methods and identifiers for one or more assayers, etc. The advisory information that is output by the system may further include additional information, such as commentary on how to operate a device according to a given analytical device method, cost of having an assayer perform the method, comments from previous users on how good a given assayer is at performing a given analysis, etc, such that the provided protocol(s) may be annotated.

In certain embodiments, the process further includes a step of the User providing content information back to the advisory module, as indicated at step 150. The update information can include any additional information from a user, such as how well a given method analyzed a given sample, whether an instrument performed adequately in a given analysis, etc., as developed in greater detail below. Another example of updated information would be an improvement on a given method (in this way multiple users can contribute and benefit from continuous improvement by others). The updated information can be provided from the user back to the advisory module in any convenient manner, e.g., by a user uploading the information to the advisory module. At this point, when a second user inputs sample ID and instrument parameter into the advisory module, the second user may receive advisory information from the advisory module that includes updated content from the first user. In this manner, content uploaded from a first user may be downloaded to a second user via the advisory module.

In the process schematically depicted in FIG. 1, an advisory module is employed to generate sample analysis advisory information in response to obtained sample identifier/instrument parameter information. As such, the advisory module performs the function of receiving the input information and generating the advisory information in response thereto.

The advisory module employed in the subject methods typically includes a collection of sample identifier and instrument parameter linked data elements stored in a memory, such as a database. While the data elements of the module may be organized in any convenient manner, in certain embodiments the module includes a plurality of samples that are each linked to and instrument parameter(s) and at least an analytical device method identifier, where the method identifier may vary in terms of content from a simple identifier of the method, e.g., a code that can be used to look up the full method in another module, or the identifier may include more complex content, such as be a complete analytical device method, where the method identifier may include annotation information, e.g., as reviewed above.

In certain embodiments, an advisory module includes a functionality that includes at least one, including a plurality of more than one, e.g., 2 or more, 5 or more, 25 or more, 50 or more, 100 or more, 500 or more, 1000 or more, 10,000 or more etc., sample identifiers and/or instrument parameters, where each sample identifier and/or instrument parameter is linked to at least an analytical device method identifier, if not an analytical device method. In this functionality, a given sample identifier and instrument parameter may be linked to more than one analytical device method or identifier thereof. Where desired the advisory module may include additional functionalities, in addition to the above functionality, such as functionalities for monitoring access to the advisory module, functionalities for controlling editing of the content of the protocol identifier functionalities, etc.

The content of the advisory module, e.g., samples represented, instruments supported, analytical device methods present therein, identities of assayers, etc, annotation information, and the like, may be controlled using any convenient protocol. In certain embodiments, the content may be maintained by a single entity, e.g., where the entity initially creates the content and then updates the content periodically.

In certain embodiments, the content may be updated by a plurality of different entities, such as analytical device users, that may upload their analytical device methods, experiences with analyzing different samples, etc., into the memory of the advisory module. As such, aspects of the methods include one or more users introducing (i.e., uploading) information to the advisory module, where the uploaded information is made available to yet other users of the system. In such embodiments, the system is configured to provide for such updated. Access to such content uploading may be controlled in any convenient manner, and may be limited to a select or predetermined group of entities, e.g., subscribes to the system, e.g., via a secure access protocol. The content may also be edited by yet another entity, such as a content manager. In addition, access to the advisory module by a user may be similarly controlled, such that only users that are subscribers to the system, or customers of a device or consummables from a manufacturer that maintains the system, etc., can access the module. As such, aspects of the invention included updated advisory modules in which the content of the advisory module has been updated one or more times following its manufacture, e.g., two or more times, 5 or more times, 10 or more times, 50 or more times, 100 or more times, 1000 or more times, etc., where the updated content may be any of a variety of different types of information, e.g., updated methods, updated results, etc., and may the updating content may be uploaded into the advisory module from a number of different sources, e.g., users, content managers, etc.

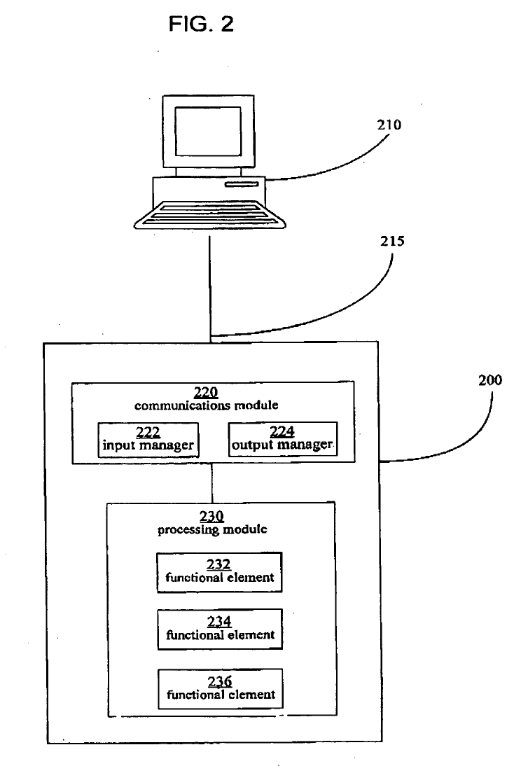

A representative embodiment of a system that includes a advisory module is shown in FIG. 2. In FIG. 2, system 200 includes communications module 220 and processing module 230, where each module may be present on the same or different platforms, e.g., servers, as is known in the art. The communications module includes an input manager 222 and output manager 224 functional elements. Input manager 222 receives information, e.g., sample identifier information, from a user e.g., locally or from a remote location (such as over the Internet). Input manager 222 processes and forwards this information to the processing module 230. Output manager 224 provides information assembled by processing module 230, e.g., an identified sample analysis protocol, to a user. The communications module 220 may be operatively connected to a user computer 210 by communications element 215, which element provides a vehicle for a user to interact with the system 200. User computer 210, shown in FIG. 2, may be a computing device specially designed and configured to support and execute any of a multitude of different applications. Computer 210 also may be any of a variety of types of general-purpose computers such as a personal computer, network server, workstation, or other computer platform now or later developed.

As reviewed above, the systems include various functional elements that carry out specific tasks on the platforms in response to information introduced into the system by one or more users. In FIG. 2, elements 232, 234 and 236 represent three different functional elements of processing module 230. At least one of the functional elements 232 of processing module 230 is a functionality for generating analytical device analysis information, and is conveniently referred to herein as the advisory information functional element of the system. Additional functional elements that may be present include, but are not limited, elements for controlling how content is introduced into the advisory information module, elements for enabling editing of the content present in the advisory information module, etc.

As summarized above, in certain embodiments the advisory information includes the identification of a complete analytical device method(s) and/or the identity of an assayer(s) that can perform the sample analysis, where the protocol may or may not be annotated. An embodiment of this method is provided schematically in FIG. 3. In the embodiment depicted in FIG. 3, a user starts the process by identifying a sample to be analyzed at the step 310 labeled start. An identifier of the to be analyzed sample, along with an instrument parameter(s), is input into the advisory module at step 320. As reviewed above, the identifier may be the name of the sample (e.g., in terms of source, date or other identifying parameters), a coded identifier of the sample (e.g., a barcode), etc., and the instrument parameter may be one or more sample analysis parameters as reviewed above, e.g., instrument type, column type, carrier type, pressure type, oven temperature, etc.

At step 330, the advisory module generates advisory information that includes the identity of at least one analytical device method for the sample based on the input sample identifier/instrument parameter information. In this step, the advisory module takes the input information and uses the input information to identify an appropriate analytical device method, as determined by a predetermined evaluation criteria (reviewed above). Following identification of the analytical device method, the identified analytical device method is then output to the user at step 340. As indicated above, the output may be made up of one or more analytical device methods. The analytical device method(s) that is output by the system may be annotated, e.g., to further include additional information, such as commentary on how to operate a device according to a given analytical device method, cost of having an assayer perform the method, comments from previous users on how good a given method will work, information, e.g., in the form of a ranking, of the extent of sample match and method effectiveness, etc. By “sample match” in the foregoing example references the similarity (such as similarity in overall chemical composition, or structure of one or more individual components of the sample) between the sample referenced by a sample identifier and an actual sample found in the database (including multiple closest matches).

At step 350, the user evaluates the method in the output advisory information to determine whether the output analytical device method is acceptable, and therefore whether to implement the output advisory information. If the method is acceptable, the user proceeds to the end of the process 380, where the user may employ the analytical device method with an analytical device to analyze a sample. In these embodiments, the advisory information may be implemented in a user mediated fashion, e.g., by the user directed the instrument to install the method in response to query, or implemented in a manner that is free of further user intervention, e.g., where the method automatically uploads onto the instrument. Alternatively, if the output method is not acceptable, the user may modify the output method and/or develop a completely new method at step 360, e.g., by employing a method developer module as described in U.S. patent application Ser. No. 11/144,199; the disclosure of which is herein incorporated by reference. At step 370 the user may accept either the modified or new method, and then proceed to end 380 where accepted method is employed to analyze the sample.

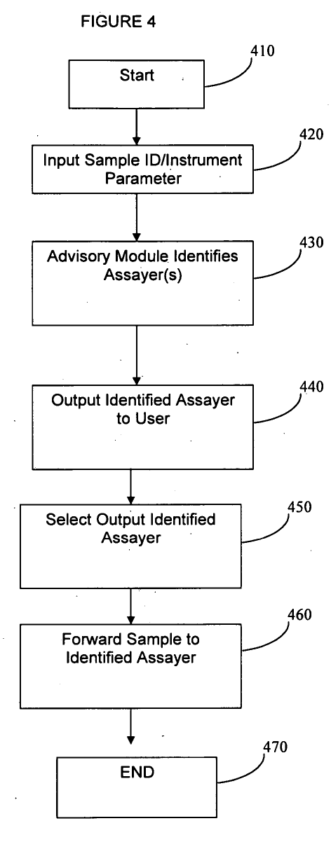

As summarized above, the protocol(s) that is identified by the advisory module in response to a submitted sample identifier/instrument parameter information is, in representative embodiments, the identity of an assayer(s) that can perform the sample analysis, where the assay identifier may or may not be annotated. An embodiment of this method is provided schematically in FIG. 4. In the embodiment depicted in FIG. 4, a user starts the process by identifying a sample to be analyzed at the step 410 labeled start. An identifier of the to be analyzed sample, along with an instrument parameter, is input into an advisory module at step 420. As reviewed above, the identifier may be the name of the sample (e.g., in terms of source, date or other identifying parameters), a coded identifier of the sample (e.g., a barcode), etc., and the instrument parameter may be one or more sample analysis parameters as reviewed above, e.g., instrument type, column type, carrier type, pressure type, oven temperature, etc.

At step 430, the advisory module identifies at least one assayer that can analyze the sample for the user based on the input sample identifier (and optionally any other sample analysis parameters, as desired). In this step, the advisory module takes the sample identifier, and optional other sample analysis parameters (if submitted), and uses the input information to identify an appropriate analytical device assayer, as determined by a predetermined evaluation criteria (reviewed above). Following identification of the assayer, the identified assayer is then output to the user at step 440. As indicated above, the output may be made up of one or more assayers. The assayer(s) that is output by the system may be annotated, e.g., to further include additional information, such as commentary on how much it will cost to have the assayer perform the analysis, a comparison of different assayers and how much they will cost, commentary on the quality of the assayer, etc.

At step 450, the user selects the identified assayer output by the advisory module, where when the output includes the identity of two or more assayers, this step includes a selection of an assayer for the sample, e.g., based on identity of the assayer, cost of the service, quality of the assayer, etc. At step 460 the user forwards the sample to the assayer for sample analysis, and then proceeds to end 470 where the user receives the sample analysis results from the assayer.

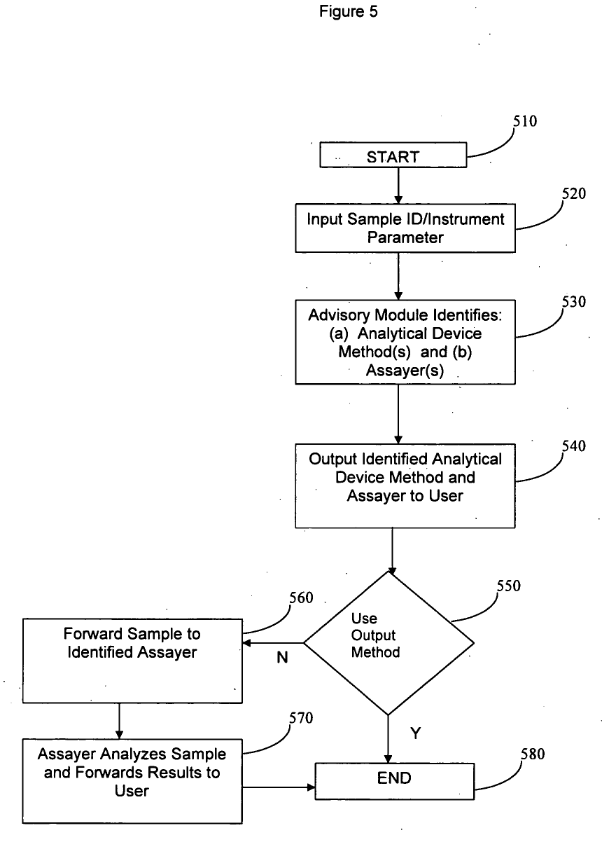

As reviewed above, in certain embodiments the advisory module may output to a user in response to an input sample identifier/instrument parameter advisory information that includes: (a) one or more analytical device methods; and (b) the identity of one or more assayers that can assay the sample for the user. A representative embodiment of such a protocol is shown in FIG. 5. In the embodiment depicted in FIG. 5, a user starts the process by identifying a sample to be analyzed at the step 510 labeled start. An identifier of the to be analyzed sample, along with an instrument parameter(s) is input into a protocol identifier module at step 520. As reviewed above, the identifier may be the name of the sample (e.g., in terms of source, date or other identifying parameters), a coded identifier of the sample (e.g., a barcode), etc.

At step 530, the advisory module identifies at least one analytical device method and at least one assayer for the sample based on the input sample identifier (and optionally any other sample analysis parameters, as desired). In this step, the advisory module takes the sample identifier, and instrument parameter(s) and uses the input information to identify an appropriate analytical device method and an assayer, as determined by a predetermined evaluation criteria (reviewed above). Following identification of the analytical device method and assayer, the identified analytical device method and assayer are then output to the user at step 540. As indicated above, the output may be made up of one or more analytical device methods. The analytical device method(s) and assayer(s) that are output by the system may be annotated, e.g., to further include additional information, such as commentary on how to operate a device according to a given analytical device method, cost of having an assayer perform the method, comments from previous users on how good a given method will work, etc.

At step 550, the user evaluates the method and assayer to determine whether to use the output analytical device on the user's analytical device or forward the sample to the assayer to have the sample assayed by the assayer. If, at step 550, the user chooses the analytical device method, the user proceeds to the end of the process 580, where the user may employ the analytical device method with an analytical device to analyze a sample. Alternatively, if the user selects the identified assayer output by the advisory module at step 550, the user forwards the sample to the assayer at step 560 for sample analysis, where the assayer forwards the results to the user at step 570 and then proceeds to end 580 where the user receives the sample analysis results from the assayer.

As indicated above, certain embodiments of the invention include at least providing to the user an option to implement the advisory information in some manner. As such, the method may include providing to the user a prompt of whether to implement or not implement the advisory action in some manner.

By implement the provided advisory action is meant to use the advisory information in some way. For example, where the advisory information includes a complete analytical device method, implementing the information may included uploading the provided method onto the instrument so that the instrument operates according to the setpoints of the provided method. In yet other embodiments where the advisory information includes suggested setpoint modifications for a method already operating an instrument, implementing may include making the suggested setpoint modifications. In yet other embodiments where the advisory information includes the identification of an assayer, implementing may include sending the sample to the identified assayer.

In certain embodiments, implementation of the advisory action, e.g., uploading of a suggested method or setpoint modification thereof, may occur free of user intervention following user acceptance of the option.

As such, certain embodiments of the subject processes include a user analyzing a sample that in some manner employs the provided advisory information. For example, where the advisory information consists of evaluation information, e.g., that the method being employed is the best method to use for a given sample on a given instrument, the user proceeds using the information by knowing that the best method, e.g., based on one or more ranking parameters, is being employed for the sample of interest. Alternatively, where the advisory information includes an analytical device method or suggestion modification of a setpoint(s) thereof, the user proceeds to analyze the sample after adopting the method or making the suggested changes to an existing method.

As described above, a feature of the subject systems and processes is that an advisory module, e.g., present in a system as depicted in FIG. 2, is employed to identify a protocol for a sample based on an input identifier for that sample. In general, the subject systems and processes are applicable to the generation of advisory information concerning a protocol for sample analysis using any type of analytical device. However, for ease of description only, the invention was described above primarily in view of the representative embodiments of chromatography methods. It should be noted, however, that the invention is not limited to these particular representative embodiments.

While the above discussion has focused for illustrations purposes only in terms interactions between a user and system, embodiments of the invention include systems in which two or more different users are in communication with the same advisory module, e.g., that is located on a central server, such that multiple different users can submit information to the same advisory module and individually receive advisory information from the same advisory module, where the advisory module may be located remotely from each user. In such embodiments, one or more of the multiple users may also upload information to the advisory module, as described above, such that the information in the advisory module is continuously updated. In this way, a given user can access the collective knowledge of multiple different entities that perform analytical analyses of samples in order to identify the best method for analyzing a given sample.

The invention also provides programming, e.g., in the form of computer program products, for use in practicing the methods. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM, ROM, flash drives, micro drives; and hybrids of these categories such as magnetic/optical storage media. One of skill in the art can readily appreciate how any of the presently known computer readable mediums can be used to create a manufacture that includes a recording of the present programming/algorithms for carrying out the above-described methodology.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

1. A process for providing chromatographic analysis advisory information to multiple users each interested in chromatographically analyzing a sample on a chromatographic instrument, said process comprising:
(a) obtaining from each of said multiple users;
(i) a sample identifier for said sample; and
(ii) an instrument parameter for said chromatographic instrument;
(b) inputting said obtained sample identifier and instrument parameter from each of said multiple users into a central chromatographic analysis advisory module that generates for each of said multiple users advisory information specific for that user for chromatographic analysis of a sample based on a sample identifier and instrument parameter for that user to obtain advisory information for chromatographic analysis of said sample specific for each of said multiple users; and
(c) forwarding advisory information to each of said multiple users.

2. The process according to claim 1, wherein said advisory module is present on an advisory module system that obtains said instrument parameter by retrieving said instrument parameter from a memory element of said chromatographic instrument.

3. The process according to claim 2, wherein said advisory module system retrieves said instrument parameter in manner that is free of user intervention.

4. The process according to claim 1, wherein said advisory module is present on an advisory module system that obtains said sample identifier by retrieving said sample identifier from a memory element of said chromatographic instrument.

5. The process according to claim 4, wherein said advisory module system retrieves said sample identifier in manner that is free of user intervention.

6. The process according to claim 1, wherein information in said advisory module is updated by at least one of said multiple users or a third party.

7. The process according to claim 1, wherein said advisory module is present at a location remote from said users.

8. The process according to claim 1, wherein said advisory information comprises information identifying an assayer that can analyze said sample.

9. The process according to claim 1, wherein said advisory information comprises a suggested analytical device method for use by said user in chromatographically analyzing said sample on said chromatographic instrument.

10. The process according to claim 1, wherein said advisory information comprises a suggested analytical device method modification to be made by said user in chromatographically analyzing said sample on said chromatographic instrument.

11. The process according to claim 1, wherein said advisory information comprises confirmation that said user has employed the best available method for chromatographically analyzing said sample on said chromatographic instrument.

12. The process according to claim 1, wherein said method further comprises providing to a user an option to implement said advisory information.

13. The process according to claim 12, wherein said process further comprises implementing said advisory information in response to user acceptance of said option.

14. The process according to claim 13, wherein said implementation occurs free of user intervention.

15. The process according to claim 14, wherein said implementation comprises adjusting one or more set points of a method operating said chromatographic instrument.

16. The process according to claim 1, wherein said advisory module comprises a memory having a plurality of different sample identifiers and instrument parameters each linked to at least an identifier of an analytical device method.

17. The process according to claim 16, wherein said identifier of an analytical device method comprises an analytical device method.

18. The process according to claim 16, wherein said identifier of an analytical device method does not include a complete analytical device method,.

19. The process according to claim 18, wherein said identifier comprises an identifier for at least one assayer that can analyze said sample.

20. The process according to claim 1, wherein said obtaining occurs before said sample is analyzed on said chromatographic instrument.

21. The process according to claim 1, wherein said obtaining occurs while said sample is being analyzed on said chromatographic instrument.

22. The process according to claim 1, wherein said communicating occurs after said sample has been analyzed on said chromatographic instrument.

23. The process according to claim 1, wherein said method further comprises said user analyzing said sample in a manner that employs said advisory information.

24. The process according to claim 1, wherein said method further comprises said user updating content of said advisory module.

25. The process according to claim 24, wherein said method further comprises a second user obtaining said updated content from said advisory module.

26. A system for providing chromatographic analysis advisory information to a user, said system comprising:
a chromatographic analysis advisory module that generates advisory information for chromatographic analysis of a sample based on a sample identifier and instrument parameter;
an input manager for receiving a sample identifier and an instrument parameter; and
an output manager for outputting advisory information generated by said advisory module.

27. The system according to claim 26, wherein said advisory module comprises a memory having a plurality of different sample identifiers and instrument parameters each linked to at least one analytical device method identifier.

28. The system according to claim 26, wherein said advisory module is configured to be updated with information.

29. The system according to claim 28, wherein advisory module is configured to be updated by a user.

30. A method comprising updating information in an advisory module of a system according to claim 26.

31. The method according to claim 30, wherein said updating is by a user.

32. A method comprising:
(a) forwarding:
(i) a sample identifier for a sample; and
(ii) an instrument parameter for a chromatographic instrument:
from a user to a system according to claim 26; and
(b) receiving from said system chromatographic analysis advisory information for said sample.

33. A computer program product comprising a computer readable storage medium having a computer program stored thereon, wherein said computer program includes an advisory module that, when loaded onto a computer, operates said computer to generate advisory information for chromatographic analysis of a sample based on a sample identifier and instrument parameter.
